(19) United States
(12) Patent Application Publication
(10) Pub. No.: US 2007/0217797 A1
(43) Pub. Date: Sep. 20, 2007

(54) Image forming apparatus, process cartridge and developing method

(75) Inventor: Norikazu Ochiai, Izu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/375,909

(22) Filed: Mar. 15, 2006

(51) Int. Cl. G03G 15/08; G03G 15/00

(52) U.S. Cl. 399/27; 399/44; 399/55

(57) ABSTRACT

Provided is a development technique of supplying a developing bias voltage having DC and AC components to a developing roller thereby to supply a developer to a photosensitive surface of a photosensitive material, which can contribute to improvement of the image quality of an image to be developed. The image forming apparatus, includes: a developing roller for supplying a developer to a photosensitive surface of a photosensitive material carrying an electrostatic latent image thereby to make the electrostatic latent image visible; and a voltage control unit for supplying a combination of a predetermined DC voltage and a predetermined AC voltage as a developing bias voltage to the developing roller as well as controlling the predetermined AC voltage so that a relation between a circumferential speed N of the developing roller and a frequency f of the AC voltage is as follows: −0.097×N+61.17≦(f/N)≦−0.093×N+67.33.

### BACKGROUND OF THE INVENTION

1. Field of the Invention

The present invention relates to a development technique by which a developing roller is used to supply a developer to a photosensitive surface of a photosensitive material, and particularly it relates to a technique of suppressing toner adhering to an out-of-image portion in dust, i.e. the occurrence of a so-called image fouling.

2. Description of the Related Art

As for a development technique of using a developing roller to supply a developer to a photosensitive surface of a photosensitive material thereby to make an electrostatic latent image formed on the photosensitive surface visible, there has been known a technique of supplying a developing bias voltage having DC and AC components to the developing roller conventionally. The DC component of a developing bias voltage herein serves to make the developer adhere to the photosensitive surface. Also, the AC component of the developing bias voltage herein serves to force the developer adhering to the photosensitive surface to vibrate thereby to make clear the boundary between a region in the photosensitive surface where an electrostatic latent image is formed and a region with no latent image formed therein.

Conventionally, there has been known a technique such that a frequency range of AC component is set to the peak voltage value width of AC component or larger, for example, 1500 Hz or higher when the peak voltage Vp-p is set to 1500V, thereby to suppress the image fouling and improve the quality of an image (JP-A-2002-351198).

Further, when e.g. a circumferential speed N of a developing roller (magroller) is 300 mm/sec in the case where 10000 Hz is used at the time of a normal speed, the AC component reciprocates 100/3 times per millimeter. Therefore, there has been known a technique that in reducing the speed to 150 mm/sec while maintaining the relation, 100/3×150=5000 Hz and as such, the frequency is used for slowdown.

However, as in JP-A-2002-351198, in the case where the frequency f is set to 1500 Hz or higher when the peak voltage Vp-p is set to 1500V, the upper limit in setting the frequency is lost. In the case where there is no upper limit for the frequency, a phenomenon that an image and a character are dissipated on a photosensitive material when the frequency is excessively high will be caused. Further, in the case where the frequency is set to 1200 Hz when the peak voltage Vp-p is 1200V, “fouling characteristic” is not made satisfying. Satisfying “fouling characteristic” can not be achieved until the frequency is set to be a high frequency of 10000 Hz or higher. In other words, fouling characteristic can not be made satisfying until the frequency is made higher than the frequency lower limit condition defined in the above-described conventional technique (JP-A-2002-351198).

Further, in the case where the frequency of AC voltage is set to 10000 Hz when the circumferential speed N of the developing roller is 300 mm/sec and the fouling characteristic is satisfying with no dust, using the frequency, 100/3*150=5000 Hz, in reducing the circumferential speed N to 150 mm/s while maintaining a relation such that the AC component reciprocates 100/3 times per millimeter of the developing roller worsens the fouling characteristic. Moreover, in such case, a satisfying fouling characteristic can not be achieved until the frequency is set to a higher one. Still further, increasing the frequency of the developing bias voltage excessively increases the reciprocating motion (vibration) of the developer on the photosensitive surface and causes an image formed on the photosensitive surface by the developer to be dissipated, which can lead to degradation of image quality.

### SUMMARY OF THE INVENTION

The invention was made to solve the above-described problems. It is an object of the invention to provide a development technique of supplying a developing bias voltage having DC and AC components to a developing roller thereby to supply a developer to a photosensitive surface of a photosensitive material, which can contribute to improvement of the image quality of an image to be developed.

In order to solve the above-described problems, an image forming apparatus according to an embodiment of the invention has a configuration characterized by including: a developing roller for supplying a developer to a photosensitive surface of a photosensitive material carrying an electrostatic latent image thereby to make the electrostatic latent image visible; and a voltage control unit for supplying a combination of a predetermined DC voltage and a predetermined AC voltage as a developing bias voltage to the developing roller as well as controlling the predetermined AC voltage so that a relation between a circumferential speed N of the developing roller and a frequency f of the AC voltage is as follows: −0.097×N+61.17≦(f/N)≦−0.093×N+67.33.

In order to solve the above-described problems, an image forming apparatus according to an embodiment of the invention has a configuration characterized by including: a developing means for making an electrostatic latent image visible; and a voltage control means for supplying a combination of a predetermined DC voltage and a predetermined AC voltage as a developing bias voltage to the developing roller as well as controlling the predetermined AC voltage so that a relation between a circumferential speed N of the developing roller and a frequency f of the AC voltage is as follows: −0.097×N+61.17≦(f/N)≦−0.093×N+67.33.

In order to solve the above-described problems, a process cartridge according to the invention is a process cartridge which can be attached to and removed from an image forming apparatus for forming an image on a sheet, and has a configuration characterized by including: an image forming apparatus having a configuration as described above; and at least one of a photosensitive material for carrying an electrostatic latent image, a charging unit for electrifying a photosensitive surface of the photosensitive material, and a cleaner for removing a developer remaining on the photosensitive surface of the photosensitive material.

In order to solve the above-described problems, a developing method according to the invention is a developing method for a developing apparatus including a developing roller for supplying a developer to a photosensitive surface of a photosensitive material carrying an electrostatic latent image thereby to make the electrostatic latent image visible, and a voltage control unit for supplying a combination of a predetermined DC voltage and a predetermined AC voltage as a developing bias voltage to the developing roller, and has a configuration characterized by including: a condition-judging step for judging a predetermined condition in which fouling characteristic worsens in the developing apparatus; and a voltage control step for controlling the predetermined AC voltage so that a relation between a circumferential speed N of the developing roller and a frequency f of the AC voltage is as follows when it is judged in the condition-judging step that the predetermined condition is satisfied:
−0.097×N+61.17≦(f/N)≦−0.093×N+67.33.

### DESCRIPTION OF THE DRAWINGS

FIG. 1 is a sectional view showing a configuration of an image forming apparatus with a developing apparatus according to the embodiment.

FIG. 2 is a sectional view showing a configuration around a process cartridge according to the embodiment.

FIG. 3 is a functional block diagram for explanation on a configuration of a developing apparatus P according to the embodiment.

FIG. 4 is a graph showing a fouling characteristic in the cases where the circumferential speed of the developing roller and the frequency are changed.

FIG. 5 is a view showing the relation between the frequency and dust on an image.

FIG. 6 is a graph showing a region which can satisfy both the condition for the fouling characteristic and the condition for the dust image.

FIG. 7 is a flowchart showing the outline of the flow of a process (developing method) in the developing apparatus according to the embodiment.

### DESCRIPTION OF THE EMBODIMENTS

A form of an image forming apparatus with a developing apparatus according to the embodiment will be described below with reference to the drawings. Herein, the image forming apparatus according to the embodiment is constituted by e.g. MFP (Multi Function Peripheral).

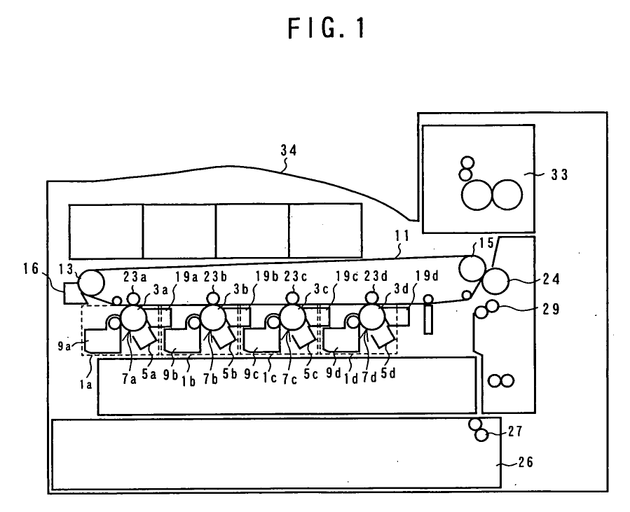

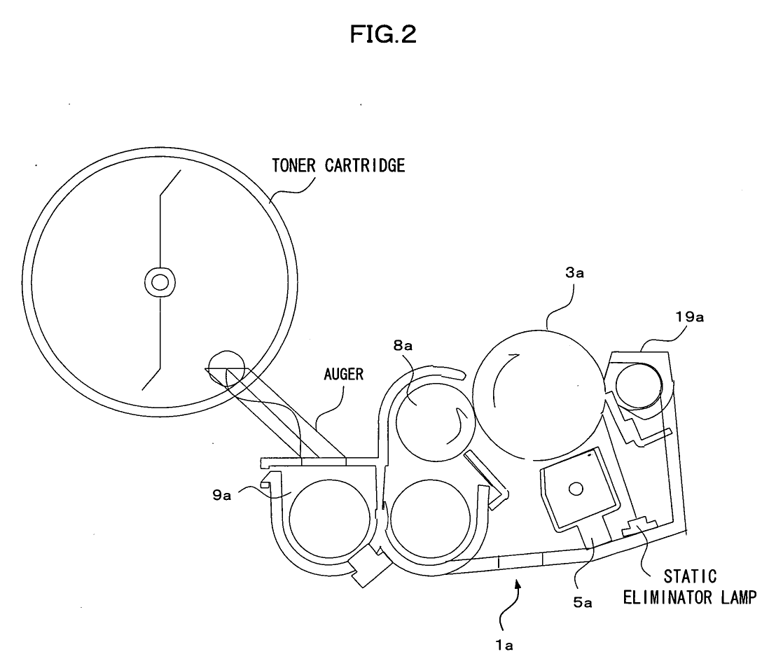

FIG. 1 is a sectional view showing a configuration of the image forming apparatus with the developing apparatus according to the embodiment. FIG. 2 is a sectional view showing a configuration around a process cartridge according to the embodiment.

As shown in FIG. 1, the image forming apparatus according to the embodiment includes process cartridges 1a, 1b, 1c and 1d as image-forming means.

The process cartridges have photoreceptor drums 3a, 3b, 3c and 3d as an image-carrier, and a developer image is formed on the photosensitive material thereof.

In FIG. 2, the photoreceptor drum 3a is in the shape of a cylinder having a diameter of 30 mm and provided rotatably in the direction of the arrow shown in the drawing.

The following are arranged along the direction of the rotation around the photoreceptor drum 3a. First, an electrification charger (a charging unit) 5a is provided facing a surface of the photoreceptor drum 3a. The electrification charger 5a electrifies the photoreceptor drum 3a negatively and uniformly. An exposure apparatus for exposing the electrified photoreceptor drum 3a to form an electrostatic latent image is provided downstream of the electrification charger 5a (on the right hand in FIG. 1). In addition a developing unit 9a is provided downstream of the exposure apparatus, which has a yellow-colored (yellow) developer kept therein and uses the developer to perform reversing development of an electrostatic latent image formed by the exposure apparatus. The developing unit 9a has a developing roller 8a (developing means) mounted therein, which supplies a developer to a photosensitive surface of the photoreceptor drum 3a carrying an electrostatic latent image thereby to make the electrostatic latent image visible. A middle-transfer belt 11, which is an image-formed medium, is mounted so as to bear on the photoreceptor drum 3a.

Downstream of a place where the belt 11 abuts on the photoreceptor drum 3a, a cleaner 19a is provided. The cleaner 19a removes and retrieves residual toner on the photosensitive material after the transfer. A static eliminator lamp eliminates static charge on a surface of the photoreceptor drum 3a by uniform light irradiation. Thus, one cycle of image formation is completed, and again the electrification charger 5a uniformly electrifies the unelectrified photoreceptor drum 3a in a subsequent image formation process.

As shown in FIG. 2, the process cartridge 1a is integrally made up of the photoreceptor drum 3a, the electrification charger 5a, the developing unit 9a and the cleaner 19a, as a cartridge, and it can be attached to and removed from the apparatus body freely.

The middle-transfer belt 11 has a length (width) substantially equal to a dimension of length of the photoreceptor drum 1a in a direction orthogonal to the direction of transportation (direction of the arrow e shown in the drawing). The belt 11 has the shape of an endless (seamless) belt, and is carried on a driving roller 15 for forcing the belt to circle at a predetermined speed and some driven rollers.

The belt 11 is formed from a 100 μm-thick polyimide with carbon uniformly distributed therein. The belt 11 has an electrical resistivity of 10ˆ9Ω, and exhibits semiconductivity.

A material for the belt 11 may be a material which has a volume resistance value of 10ˆ to 10ˆ11 Ωcm and exhibits semiconductivity. In addition to polyimide with carbon uniformly distributed therein, such material may be, for example, polyethylene terephthalate, polycarbonate, polytetrafluoroethylene, polyvinylidene fluoride and others, in which electroconductive particles of carbon or the like are distributed. Otherwise, a polymer film, whose electrical resistance is adjusted by composition adjustment instead of use of electroconductive particles, may be used. Further, a polymer film like this may be mixed with an ionic conductive substance, or may be made of a rubber material of silicon rubber, urethane rubber or the like, which is relatively low in its electrical resistance.

On the belt 11 are arranged the process cartridges 1b, 1c and 1d in addition to the process cartridge 1a along the direction of transportation of the belt 11 between the driving roller 13 and the secondary transfer opposite roller 13.

Any of the process cartridges 1b, 1c and 1d has the same configuration as the process cartridge 1a. That is, the photoreceptor drums 1b, 1c and 1d are provided in substantially central portions of the respective process cartridges. Electrification chargers 5b, 5c and 5d are provided around the photoreceptor drums, respectively. Also, their configuration in which developing units 9b, 9c and 9d and cleaners 19b, 19c and 19d are provided downstream of the respective electrification chargers is the same as that of the process cartridge 1a. They are different from the process cartridge 1a in developers kept in the developing units. The developing unit 19b keeps a magenta developer. The developing unit 19c keeps a cyan developer. The developing unit 19d keeps a black developer.

The belt 11 abuts on the individual photoreceptor drums sequentially.

In the vicinities of the places where the belt 11 abuts on the individual photoreceptor drums, transfer apparatuses 23a, 23b, 23c and 23d as transfer means are provided corresponding to the respective photoreceptor drums. The is, each transfer apparatus 23 is provided above the corresponding photoreceptor drum with its rear surface in contact with the belt 11 and opposed to the process cartridge through the belt 11.

The transfer member 23a is connected to a voltage-applying means, i.e. a DC power source 25a which is positive (+), not shown in the drawing. Likewise, the transfer members 23b, 23c and 23d are connected to the DC power sources 25b, 25c and 25d respectively, which are not shown in the drawing.

On the other hand, a paper-feed cassette 26 for stocking a paper sheet P is provided in a lower portion of the image forming portion in FIG. 1. In the body of the image forming apparatus, a pickup roller 27 for picking up a paper sheet P one by one from the paper-feed cassette 26 is provided. Near the secondary transfer roller, a pair of resist rollers 29 is provided rotatably. The pair of resist rollers 29 supplies a paper sheet P, with a predetermined timing, to a secondary transfer portion where the secondary transfer roller 24 and the secondary transfer opposite roller 13 are confronted each other with the belt sandwiched therebetween.

Further, in FIG. 1, there are also provided a fixing unit 33 for fixing the developer on a paper sheet and a paper-ejecting portion 34 to which a paper sheet P subjected to the fixation by the fixing unit is ejected.

The color image forming operation of the image forming apparatus configured as described above will be described. When start of image formation is directed, the photoreceptor drum 3a starts rotating in response to a driving force from a driving mechanism (not shown). The electrification charger 5a electrifies uniformly the photoreceptor drum 3a to −600V approximately. The exposure apparatus 7a irradiates the photoreceptor drum 3a, which has been uniformly electrified by the electrification charger 5a, with light according to an image to be recorded, and then forms an electrostatic latent image. The developing unit 9a keeps a developer (yellow (Y) toner+ferrite carrier: binary developer) therein. The developing unit 9a uses a developing bias power source (not shown) to provide a bias with a value of −380V to a developing sleeve (not shown) to form an electric field for development between the photosensitive drum 3a and itself. The negatively electrified Y toner adheres to a region of an image portion potential (high potential portion: its sign is considered here) of an electrostatic latent image of the photosensitive material 3a in reversing development.

Subsequently, the developing unit 9b uses a magenta developer to develop an electrostatic latent image and forms a magenta toner (M toner) image on the photosensitive drum 3b. In this case, M toner has an average particle size of about 7 μm like Y toner, and is negatively electrified by triboelectric charging with ferrite magnetic carrier particles (not shown) with an average particle size of about 60 μm. The value of a developing bias is about −380V as in the case of the developing unit 3a, which is applied to the developing sleeve (the configuration of the developing unit is the same as that of the developing unit 9a) by the bias power source (not shown). As for the direction of the electric field for development, it runs from the surface of the photosensitive drum 3b toward the developing sleeve in an image portion; the negatively electrified M toner adheres to a high potential portion of a latent image.

In a transfer region Ta formed by the photoreceptor drum 3a, the belt 11, and the transfer member 23a, a bias voltage of about +1000V is applied to the transfer member 23a. A transfer electric field is formed between the transfer member 23a and the photoreceptor drum 3a; a yellow toner image on the photoreceptor drum 3a is transferred onto the belt 11 according to the transfer electric field. In this way, a magenta developer image, a cyan developer image and a black developer image are superposed on a Y (yellow) toner developer image and then multi-transferred thereto in turn. On the other hand, the pickup roller 27 picks up a paper sheet P out of the paper-feed cassette 26, and the pair of resist rollers 29 feeds the paper sheet P into the secondary transfer portion.

In the secondary transfer portion, a predetermined bias is applied to the secondary transfer opposite roller to form a transfer electric field between the secondary transfer roller and the its opposite roller with the belt sandwiched therebetween, whereby multicolor toner images on the belt 11 are transferred to a paper sheet P collectively. The developer images of the respective colors thus transferred at a time are fixed on the paper sheet P by the fixing unit 33, whereby a color image is formed. The paper sheet P after the fixing is ejected onto the paper-ejecting portion 34.

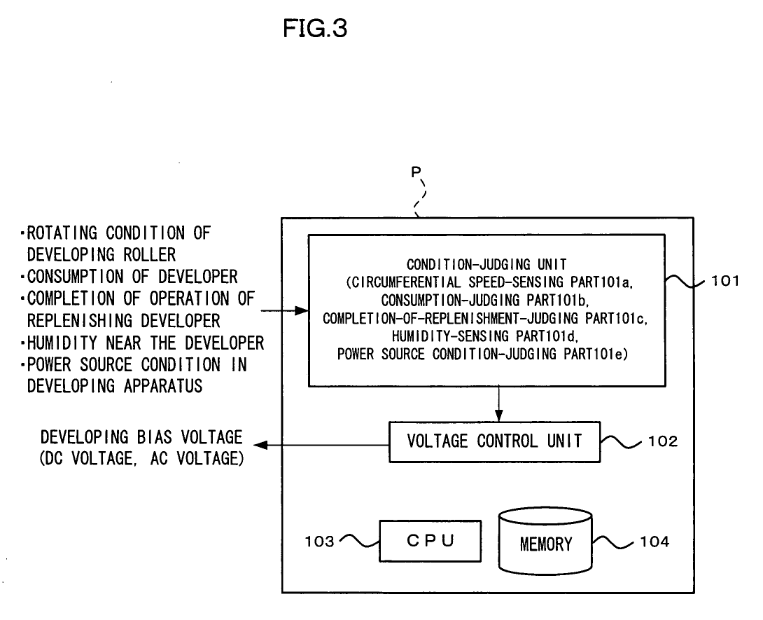

FIG. 3 is a functional block diagram for explanation on a configuration of a developing apparatus P according to the embodiment. The developing apparatus P according to the embodiment has a configuration that it includes a condition-judging unit 101, a voltage control unit 102, a CPU 103, and a MEMORY 104.

The condition-judging unit 101 includes: a circumferential speed-sensing part 101a; a consumption-judging part 101b; a completion-of-replenishment-judging part 101c; a humidity-sensing part 101d; and a power source condition-judging part 101e. The condition-judging unit 101 judges a predetermined condition in which the fouling characteristic worsens in the developing apparatus P.

Incidentally, the circumferential speed-sensing part 101a judges the rotating condition of the developing roller. The consumption-judging part 101b judges the consumption of the developer for an image formed with respect to a photosensitive surface. The completion-of-replenishment-judging part 101c judges the completion of the operation of replenishing the developer for supply to the photosensitive surface by the developing roller. The humidity-sensing part 101d senses the humidity in the vicinity of the developer supplied to the photosensitive surface at least by the developing roller. The power source condition-judging part 101e judges a condition of the power source in the developing apparatus.

When it is judged in the condition-judging unit 101 that a predetermined condition is satisfied, the voltage control unit 102 supplies a combination of a predetermined DC voltage and a predetermined AC voltage as a developing bias voltage to the developing roller, and controls the predetermined AC voltage so that the relation between the circumferential speed N of the developing roller and the frequency f of the AC voltage is as follows:
−0.097×N+61.17≦(f/N)≦−0.093×N+67.33

Specifically, the voltage control unit 102 controls the predetermined AC voltage as described above in the following cases; when the circumferential speed of the developing roller sensed by the circumferential speed-sensing part 101a is equal to or below a predetermined circumferential speed; when the consumption of the developer judged by the consumption-judging part 101b exceeds a predetermined threshold; when it is judged in the completion-of-replenishment-judging part 101c that replenishment of the developer has been completed; when the humidity sensed by the humidity-sensing part 101d exceeds a predetermined threshold (e.g. 60% in absolute humidity); or when it is judged in the power source condition-judging part 101e that the power source of the developing apparatus has been in OFF state for a predetermined period (e.g. one week) or a longer time. In addition, the above-described control may be made in a season during which the fouling characteristic is easy to worsen and in a use area where the fouling characteristic is easy to worsen.

CPU 103 serves to perform various processes in the developing apparatus. Also, CPU 103 serves to execute a program stored in MEMORY 104 thereby to actualize the various functions. MEMORY 104 is composed of e.g. HDD, ROM or RAM, and serves to store various pieces of information and programs, which are utilized in the developing apparatus.

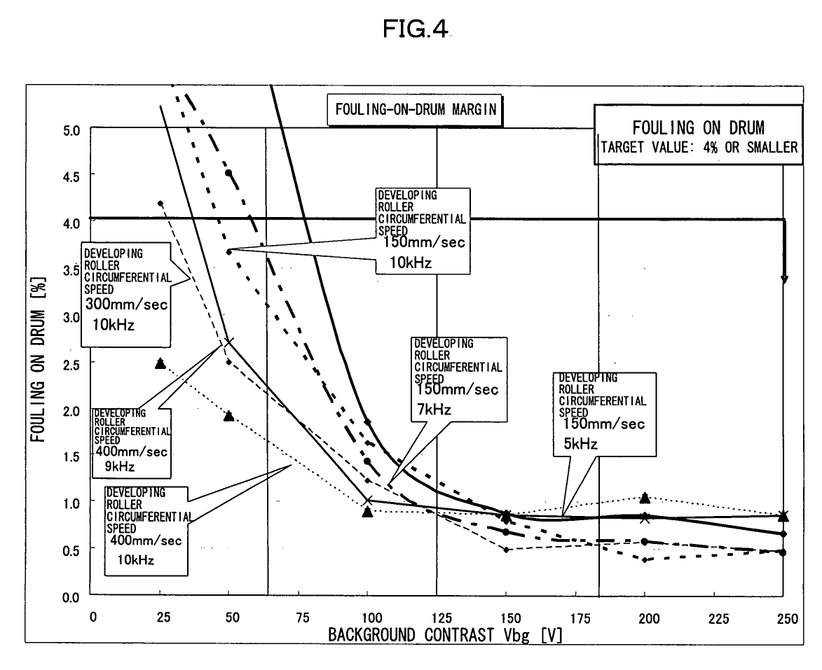

Subsequently, the effect resulting from control of the developing bias voltage in the developing apparatus according to the embodiment will be described. FIG. 4 is a graph showing “Fouling Characteristic (which represents easiness of occurrence of image fouling)” in the cases where the circumferential speed of the developing roller and the frequency are changed. The horizontal axis takes the difference between an electrification potential of the photosensitive material of a white background portion and a potential applied to the developing roller (hereinafter referred to as background contrast potential); the vertical axis takes a value taken by unsticking toner, which adheres to the photosensitive material of a white background portion downstream of a toner supply portion of the photosensitive material and the developing roller, by a piece of tape, and then measuring the reflectivity of the piece of tape.

A region where the background contrast potential is within 125+60(V) is a range in which the background contrast potential is changed. The fouling characteristic is regarded as being in a satisfying condition when the reflectivity takes on a value equal to or below 4% in the range.

From FIG. 4, when the circumferential speed of the developing roller is 300 mm/sec, the fouling characteristic falls in a satisfying range at 10000 Hz. In the case where the circumferential speed of the developing roller is 150 mm/sec, the fouling characteristic is in an unsatisfying range at a frequency of 5000 Hz, but it falls in a satisfying range from a frequency of 7000 Hz, and the fouling characteristic is more satisfying at 10000 Hz. When the circumferential speed of the developing roller is 400 mm/sec, the fouling characteristic falls in a satisfying range at 9000 Hz and 10000 Hz.

It is seen from the characteristic of the graph at 150 mm/sec that the fouling characteristic is made better as the frequency is increased. Though the toner is influenced by an AC component, a little toner reciprocates because of a high frequency. The toner vibrates in a portion to which it is attracted by a potential of a DC component, whereas the toner is attracted by the potential of a DC component from the photosensitive material toward the developing roller in a portion where there is no latent image on the photosensitive material and as such, the fouling becomes satisfying.

The toner is distributed in its mass and quantity of electrification. Therefore, the toner includes an aggregate of toner having a large mass and an aggregate of toner having a small mass, and an aggregate with a large quantity of electrification and an aggregate with a small quantity of electrification. Also, the toner includes an aggregate of toner which is influenced by the potential easily and an aggregate of toner which is less influenced by the potential. Further, the toner includes an aggregate of toner which is made to reciprocate and an aggregate of toner which is made to reciprocate little, but vibrate. However, as the frequency is made higher, the amount of toner which reciprocates is reduced and the amount of toner which vibrates in the potential field is increased.

Making a comparison between the cases of the same frequency, 10000 Hz, it is seen that as the circumferential speed of the developing roller is made higher, such as from 150 mm/sec to 300 mm/sec and further to 400 mm/sec, the fouling characteristic is made better. The reason for this can be considered as follows: the time during which the toner is in contact with the photosensitive material is made longer and as such, the toner is made easier to adhere owing to the intermolecular force. Therefore, with a common frequency, the developing roller's frequency per millimeter is made higher when the speed is slowed, but beyond that, the time during which the toner is in contact with the photosensitive material is made longer and as such, the image is made easier to foul.

In the condition where the developing roller's frequency per millimeter is made common, when a comparison is made between the cases of 150 mm/sec at 5000 Hz and 300 mm/sec at 10000 Hz, the fouling characteristic worsens in the case of 150 mm/sec at 5000 Hz. The reason for this can be considered as follows: the time during which the toner is in contact with the photosensitive material is longer in the case of 150 mm/sec and as such, the intermolecular force is made stronger and the toner is made easier to adhere. Therefore, in the case of 150 mm/sec, unless the developing roller's frequency per millimeter is increased to 7000 Hz or higher, the fouling characteristic doesn't reach a satisfying region.

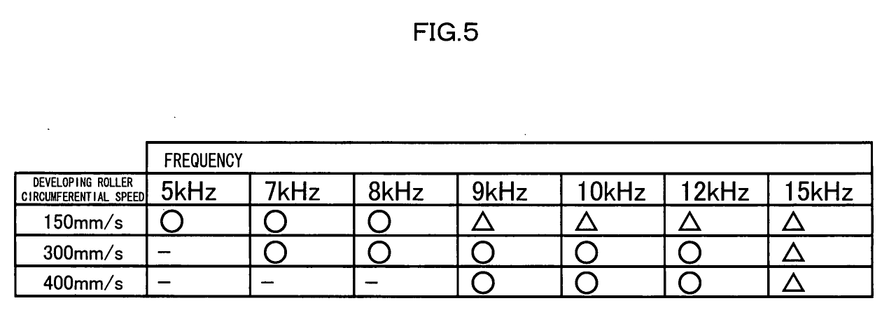

FIG. 5 is a view showing the relation between the frequency and dust on an image. In the drawing, “Open Circle” shows a satisfying condition where the quantity of dust image is small; “Triangle” shows an unsatisfying condition where a dust image appears. As the developing roller's frequency per millimeter is made higher, “Dust Image” appears, which makes unclear the boundary between a region in which an image should be formed and a region in which any image should not be formed. The reason for this can be considered as follows: on a downstream side of a latent image of the photosensitive material, the toner on the developing roller facing a portion on the downstream side is applied with a high frequency, whereby both a force of attracting from the latent image portion and a force of attracting onto the developing roller are exerted at the boundary of the latent image portion, and thus the quantity of toner suspending in a space between the latent image portion and the developing roller is increased. When the frequency is made a low frequency, the suspending toner is made prone to reciprocate toward either the latent image portion of the photosensitive material or an upper portion of the developing roller and as such, the toner tends to adhere to either the latent image portion or the developing roller. As a result, the quantity of the suspending toner is reduced. Thus, when the frequency is too high, toner suspending downstream of the latent image appears; such toner disturbs an image as dust when the toner adheres to a portion other than the latent image downstream of the latent image.

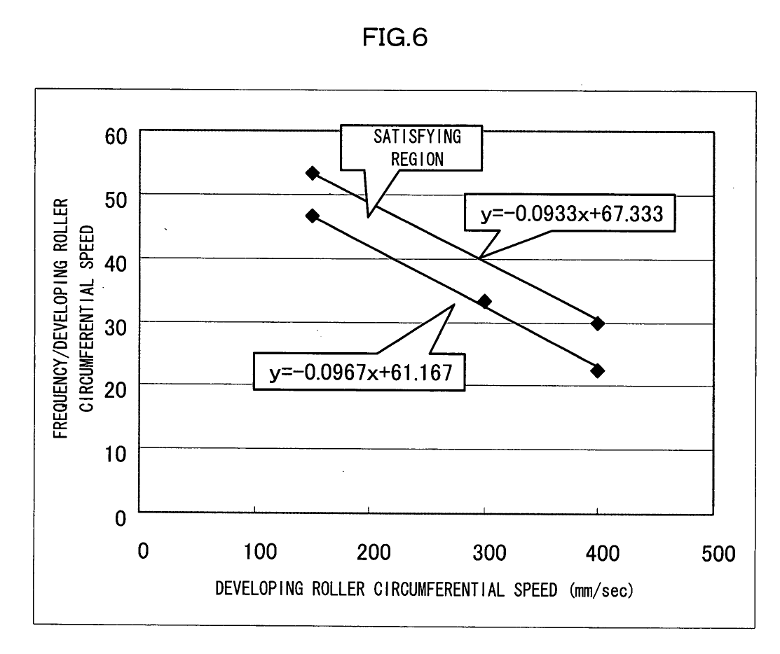

FIG. 6 is a graph showing a region which can satisfy both the condition for the fouling characteristic and the condition for the dust image. From FIGS. 4 and 5, the following cases were satisfying conditions: the satisfying frequency is 7000-8000 Hz when the developing roller circumferential speed is 150 mm/sec; the frequency is 10000-12000 Hz when the developing roller circumferential speed is 300 mm/sec; and the frequency is 9000-12000 Hz when developing roller circumferential speed is 400 mm/sec. A region which satisfies the fouling characteristic and in which no dust image appears can be shown by the following expression:
−0.097×N+61.17≦(f/N)≦−0.093×N+67.33 (1)

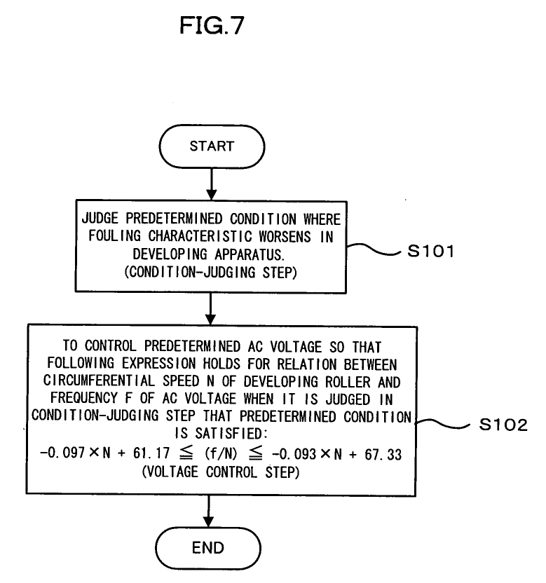

FIG. 7 is a flowchart showing the outline of the flow of a process (developing method) in the developing apparatus according to the embodiment.

The condition-judging unit 101 judges a predetermined condition in which the fouling characteristic worsens in the developing apparatus (Condition-judging step) (S101).

Specifically, the condition-judging step includes: judging the rotating condition of the developing roller; judging the consumption of the developer for an image formed on a photosensitive surface; judging completion of the operation of replenishing the developer for supply to the photosensitive surface by the developing roller; sensing the humidity in the vicinity of the developer supplied to the photosensitive surface at least by the developing roller; and judging the condition of the power source in the developing apparatus.

In the case where it is judged in the condition-judging step that the predetermined condition is satisfied, the voltage control unit 102 controls a predetermined AC voltage so that the relation between the circumferential speed N of the developing roller and the frequency f of the AC voltage is as follows (Voltage control step) (S102):
−0.097×N+61.17≦(f/N)≦−0.093×N+67.33.

When it is judged in the condition-judging step that the circumferential speed of the developing roller is equal to or smaller than the predetermined circumferential speed, in the voltage control step, the relation between the circumferential speed N of the developing roller and the frequency f of the AC voltage is set as described above in the following cases; when the consumption of the developer judged in the condition-judging step to exceed the predetermined threshold; when it is judged in the condition-judging step that replenishment of the developer has been completed; when the humidity sensed in the condition-judging step exceeds the predetermined threshold; or when it is judged in the condition-judging step that the power source of the developing apparatus has been in OFF state for the predetermined period or a longer time.

The above-described steps in the process (developing method) in the developing apparatus are implemented by making CPU 103 execute a developing program stored in MEMORY 104.

In the embodiment, the case where a function for embodying the invention is previously recorded inside the apparatus has been described. However, the invention is not so limited, the same function may be downloaded from a network to the apparatus, or the same function recorded in a recording medium may be installed on the apparatus. The recording medium may have any form as long as it is a recording medium such as a CD-ROM which a program can be held in and the apparatus can read. Also, the function previously obtained through installation or download like this may be actualized by cooperation with OS (Operating System) inside the apparatus.

In the above-described embodiment, the arrangement in that the frequency of an AC voltage as the developing bias voltage is set within a predetermined range. However, the invention is not so limited. For example, it is needless to say that the same effect can be achieved by setting the peak voltage of the AC voltage to an optimal value.

Therefore, according to the embodiment, when the frequency of AC voltage of the developing bias voltage is made a high frequency equal to or above the lower limit in Expression (1), despite the fact that toner is influenced by the AC component, the amount of reciprocating toner is small because of the high frequency, and the toner vibrates in a portion to which the toner is attracted by the potential of the DC component and it is attracted by the potential of DC component from the photosensitive material side toward the developing roller side in a portion in which there is no latent image on the photosensitive material. As a result, the fouling condition is made better.

In general, when the frequency of AC voltage of the developing bias voltage is made a low frequency, the suspending toner is made prone to reciprocate toward either the latent image portion of the photosensitive material or an upper portion of the developing roller and as such, the toner tends to adhere to either the latent image portion or the developing roller. As a result, the quantity of the suspending toner is reduced. Thus, when the frequency is too high, toner suspending downstream of the latent image appears; such toner disturbs an image as dust when the toner adheres to a portion other than the latent image downstream of the latent image.

Hence, when the frequency is made a frequency equal to or below the upper limit in Expression (1), it becomes possible to avoid the following situation: on a downstream side of a latent image of the photosensitive material, the toner on the developing roller facing a portion on the downstream side is applied with a high frequency, whereby both a force of attracting from the latent image portion and a force of attracting onto the developing roller are exerted at the boundary of the latent image portion, and thus the quantity of toner suspending in a space between the latent image portion and the developing roller is increased.

Detail of the invention has been described based on the particular embodiment. However, it will be obvious to those skilled in the art that various changes and modifications may be made without departing from the spirit and scope of the invention.

As described above in detail, the invention can provide a development technique of supplying a developing bias voltage having DC and AC components to a developing roller thereby to supply a developer to a photosensitive surface of a photosensitive material, which can contribute to improvement of the image quality of an image to be developed.

1. An image forming apparatus, comprising:
a developing roller that supplies a developer to a photosensitive surface of a photosensitive material carrying an electrostatic latent image thereby to make the electrostatic latent image visible; and
a voltage control unit that supplies a combination of a predetermined DC voltage and a predetermined AC voltage as a developing bias voltage to the developing roller and controlling the predetermined AC voltage so that a relation between a circumferential speed N of the developing roller and a frequency f of the AC voltage is as follows:
−0.097×N+61.17<(f/N)<−0.093×N+67.33.

2. The image forming apparatus of claim 1, further comprising a circumferential speed-sensing part that judges a rotating condition of the developing roller, wherein when a circumferential speed of the developing roller sensed by the circumferential speed-sensing part is equal to or below a predetermined circumferential speed, the voltage control unit sets the relation between a circumferential speed N of the developing roller and a frequency f of the AC voltage so that the following expression holds:
−0.097×N+61.17≦(f/N)≦−0.093×N+67.33.

3. The image forming apparatus of claim 1, further comprising a consumption-judging part that judges a consumption of the developer for an image formed with respect to the photosensitive surface, wherein when the consumption of the developer judged by the consumption-judging part exceeds a predetermined threshold, the voltage control unit sets the relation between a circumferential speed N of the developing roller and a frequency f of the AC voltage so that the following expression holds:
−0.097×N+61.17≦(f/N)≦−0.093×N+67.33.

4. The image forming apparatus of claim 1, further comprising a completion-of-replenishment-judging part that judges completion of an operation of replenishing the developer for supply to the photosensitive surface by the developing roller, wherein when it is judged by the completion-of-replenishment-judging part that replenishment of the developer has been completed, the voltage control unit keeps the relation between a circumferential speed N of the developing roller and a frequency f of the AC voltage set so that the following expression holds during a time after completion of replenishment of the developer until a predetermined period elapses:
−0.097×N+61.17<(f/N)≦−0.093×N+67.33.

5. The image forming apparatus of claim 1, further comprising a humidity-sensing part that senses a humidity in a vicinity of the developer supplied to the photosensitive surface at least by the developing roller, wherein when the humidity sensed by the humidity-sensing part exceeds a predetermined threshold, the voltage control unit sets the relation between a circumferential speed N of the developing roller and a frequency f of the AC voltage so that the following expression holds:
−0.097×N+61.17≦(f/N)≦−0.093×N+67.33.

6. The image forming apparatus of claim 1, further comprising a power source condition-judging part that judges a condition of a power source in the image forming apparatus, wherein when it is judged by the power source condition-judging part that the power source of the image forming apparatus has been in OFF state for a predetermined period or a longer time, the voltage control unit sets the relation between a circumferential speed N of the developing roller and a frequency f of the AC voltage so that the following expression holds:
−0.097×N+61.17≦(f/N)≦−0.093×N+67.33.

7. A process cartridge which can be attached to and removed from the image forming apparatus of claim 1, comprising:
a photosensitive material that carries an electrostatic latent image; and
at least one of a charging unit for electrifying a photosensitive surface of the photosensitive material and a cleaner for removing a developer remaining on the photosensitive surface of the photosensitive material.

8. An image forming apparatus, comprising:
a developing means for making an electrostatic latent image visible; and
a voltage control means for supplying a combination of a predetermined DC voltage and a predetermined AC voltage as a developing bias voltage to the developing means and controlling the predetermined AC voltage so that a relation between a circumferential speed N of the developing means and a frequency f of the AC voltage is as follows:
−0.097×N+61.17≦(f/N)<−0.093×N+67.33.

9. The image forming apparatus of claim 8, wherein further comprising a circumferential speed-sensing part for judging a rotating condition of the developing means, wherein when a circumferential speed of the developing means sensed by the circumferential speed-sensing part is equal to or below a predetermined circumferential speed, the voltage control means sets the relation between a circumferential speed N of the developing means and a frequency f of the AC voltage so that the following expression holds:
−0.097×N+61.17≦(f/N)≦−0.093×N+67.33.

10. The image forming apparatus of claim 8, further comprising a consumption-judging part for judging a consumption of the developer for an image formed with respect to the photosensitive surface, wherein when the consumption of the developer judged by the consumption-judging part exceeds a predetermined threshold, the voltage control means sets the relation between a circumferential speed N of the developing means and a frequency f of the AC voltage so that the following expression holds:
−0.097×N+61.17≦(f/N)≦−0.093×N+67.33.

11. The image forming apparatus of claim 8, having a completion-of-replenishment-judging part for judging completion of an operation of replenishing the developer for supply to the photosensitive surface by the developing means, wherein when it is judged by the completion-of-replenishment-judging part that replenishment of the developer has been completed, the voltage control means keeps the relation between a circumferential speed N of the developing means and a frequency f of the AC voltage set so that the following expression holds during a time after completion of replenishment of the developer until a predetermined period elapses:
−0.097×N+61.17≦(f/N)≦−0.093×N+67.33.

12. The image forming apparatus of claim 8, further comprising a humidity-sensing part for sensing a humidity in a vicinity of the developer supplied to the photosensitive surface at least by the developing means, wherein when the humidity sensed by the humidity-sensing part exceeds a predetermined threshold, the voltage control means sets the relation between a circumferential speed N of the developing means and a frequency f of the AC voltage so that the following expression holds:
−0.097×N+61.17≦(f/N)≦−0.093×N+67.33.

13. The image forming apparatus of claim 8, further comprising a power source condition-judging part for judging a condition of a power source in the image forming apparatus, wherein when it is judged by the power source condition-judging part that the power source of the image forming apparatus has been in OFF state for a predetermined period or a longer time, the voltage control means sets the relation between a circumferential speed N of the developing means and a frequency f of the AC voltage so that the following expression holds:
−0.097×N+61.17≦(f/N)≦−0.093×N+67.33.

14. A process cartridge which can be attached to and removed from the image forming apparatus of claim 8, comprising:
a photosensitive material for carrying an electrostatic latent image; and
at least one of a charging unit for electrifying a photosensitive surface of the photosensitive material and a cleaner for removing a developer remaining on the photosensitive surface of the photosensitive material.

15. A developing method for a developing apparatus including a developing roller for supplying a developer to a photosensitive surface of a photosensitive material carrying an electrostatic latent image thereby to make the electrostatic latent image visible, and a voltage control unit for supplying a combination of a predetermined DC voltage and a predetermined AC voltage as a developing bias voltage to the developing roller, comprising:
a condition-judging step for judging a predetermined image-forming condition; and
a voltage control step for controlling the predetermined AC voltage so that a relation between a circumferential speed N of the developing roller and a frequency f of the AC voltage is as follows when it is judged in the condition-judging step that the predetermined condition is satisfied:
−0.097×N+61.17≦(f/N)<−0.093×N+67.33.

16. The developing method of claim 15, wherein the condition-judging step includes judging a rotating condition of the developing roller, and
the voltage control step includes setting the relation between a circumferential speed N of the developing roller and a frequency f of the AC voltage so that the following expression holds when it is judged in the condition-judging step that the circumferential speed of the developing roller is equal to or below a predetermined circumferential speed:
−0.097×N+61.17≦(f/N)≦−0.093×N+67.33.

17. The developing method of claim 15, wherein the condition-judging step includes judging a consumption of the developer for an image formed with respect to the photosensitive surface, and
the voltage control step includes setting the relation between a circumferential speed N of the developing roller and a frequency f of the AC voltage so that the following expression holds when the consumption of the developer judged in the condition-judging step exceeds a predetermined threshold:
−0.097×N+61.17≦(f/N)≦−0.093×N+67.33.

18. The developing method of claim 15, wherein the condition-judging step includes judging completion of an operation of replenishing the developer for supply to the photosensitive surface by the developing roller, and the voltage control step includes keeping the relation between a circumferential speed N of the developing roller and a frequency f of the AC voltage set so that the following expression holds during a time after completion of replenishment of the developer until a predetermined period elapses, when it is judged in the condition-judging step that replenishment of the developer has been completed:
−0.097×N+61.17≦(f/N)≦−0.093×N+67.33.

19. The developing method of claim 15, wherein the condition-judging step includes sensing a humidity in a vicinity of the developer supplied to the photosensitive surface at least by the developing roller, and the voltage control step includes setting the relation between a circumferential speed N of the developing roller and a frequency f of the AC voltage so that the following expression holds when the humidity sensed in the condition-judging step exceeds a predetermined threshold:
−0.097×N+61.17≦(f/N)≦−0.093×N+67.33.

20. The developing method of claim 15, wherein the condition-judging step includes judging a condition of a power source in the developing apparatus, and
the voltage control step includes setting the relation between a circumferential speed N of the developing roller and a frequency f of the AC voltage so that the following expression holds when it is judged in the condition-judging step that the power source of the developing apparatus has been in OFF state for a predetermined period or a longer time:
−0.097×N+61.17≦(f/N)≦−0.093×N+67.33.
